(19) United States
(12) Patent Application Publication
(10) Pub. No.: US 2026/0019549 A1
(43) Pub. Date: Jan. 15, 2026

(54) STEREO IMAGE GENERATING APPARATUS, STEREO IMAGE GENERATINGMETHOD, AND PROGRAM

(71) Applicant: NIPPON TELEGRAPH AND TELEPHONE CORPORATION, Tokyo (JP)

(72) Inventors: Taiki FUKIAGE, Tokyo (JP); Shinya NISHIDA, Tokyo (JP)

(73) Assignee: NIPPON TELEGRAPH AND TELEPHONE CORPORATION, Tokyo (JP)

(21) Appl. No.: 18/992,941

(22) PCT Filed: Jul. 12, 2022
(86) PCT No.: PCT/JP2022/027416

§ 371 Date: Jan. 9, 2025

(51) Int. Cl. H04N 13/271; H04N 13/128; H04N 13/178; H04N 13/383

(52) U.S. Cl. CPC H04N 13/271; H04N 13/128; H04N 13/178; H04N 13/383

(57) ABSTRACT

A stereo image generation device according to the disclosed technology is a device that generates a stereo image from image information, a disparity map of an image, and viewpoint information of an observer, the stereo image generation device including a disparity remapping function generation unit, a multi-band disparity map generation unit, a disparity guidance pattern generation unit, and an image pair generation unit. The disparity remapping function generation unit generates a remapping function for converting an amount of disparity into an amount of disparity within a predetermined range. The multi-band disparity map generation unit generates a disparity map by correcting a multi-band disparity map with a disparity remapping function. The disparity guidance pattern generation unit generates an image by shifting a band-pass decomposed image by λ/2 in a spatial phase, and generates a disparity guidance pattern by weighting and adding the image with a value of the multi-band disparity map. The image pair generation unit generates a stereo image pair by adding and subtracting the image information and the disparity guidance pattern.

### TECHNICAL FIELD

The disclosed technology relates to a technology that generates stereo images to be presented on a stereoscopic television (3D TV) or the like according to an observer's viewpoint position.

### BACKGROUND ART

When observing the outside world in a natural environment, the human eye coordinates convergence eye movements and lens adjustment.

Specifically, when gazing at an object in a 3D environment, the eyeball rotates to minimize the disparity of the object on the retina in the central visual field, and at the same time the lens is adjusted to focus on the object. Accordingly, the point where the lines of sight of the left and right eyeballs intersect (convergence distance) and the focal length are maintained to match, regardless of the depth position of the object gazed at. “Natural Observation 101” in FIG. 1 illustrates the situation when the focal length and convergence distance match.

However, when observing a stereoscopic image displayed on a 3D TV, for example, the relationship between convergence eye movement and focus adjustment is disrupted, and while the convergence distance changes according to the disparity of the displayed image, the focal length is always fixed to the screen surface of the display. Therefore, this is considered to cause fatigue and discomfort when observing stereoscopic images. “Stereo 3D Observation 102” in FIG. 1 illustrates the situation when the convergence distance becomes shorter than the focal length.

As a method for solving this problem, a method has been devised in the past in which the viewpoint position of a 3D observer is measured and the disparity of the presented image is remapped on the basis of the measured viewpoint position (NPL 1). In this method, by dynamically manipulating the disparity so that the disparity near the 3D observer's viewpoint position matches the screen surface, a state is created in which both the convergence distance and the focal length are maintained at the distance to the screen. FIG. 2 schematically illustrates this situation. The observer's viewpoint is measured, and in a case where the viewpoint is on a rectangular parallelepiped, the disparity related to the rectangular parallelepiped is adjusted to near zero, and the disparity of figures other than the rectangular parallelepiped is compressed. In a case where the viewpoint moves to a cylinder, the disparity related to the cylinder is adjusted to near zero, and the disparity of figures other than the cylinder is compressed.

Another problem with a 3D TV is that when an observer who is not wearing 3D glasses observes a 3D image, the left and right stereo images may overlap, resulting in blurred images or double images. In order to solve this problem, NPL 2 devises a stereo image generation technique (hereinafter referred to as Hidden Stereo) that does not generate double images when left and right images are added together.

FIG. 3 schematically illustrates Hidden Stereo. In a case where the left image L=I+D and the right image R=I−D can be separated using 3D glasses, a 3D image can be observed. In a case where there are no glasses and L and R cannot be separated, a 2D image (L+R=2I) with disparity information canceled can be observed.

### CITATION LIST

### Non Patent Literature

[NPL 1] P. Kellnhofer et al., “GazeStereo3D: seamless disparity manipulations,” ACM Trans. Graph., vol. 35, No. 4, Article 68, pp. 1-13, July 2016.

[NPL 2] T. Fukiage et al., “Hiding of Phase-Based Stereo Disparity for Ghost-Free Viewing Without glasses,” ACM Trans. Graph., vol. 36, No. 4, pp. 1-17, July 2017.

### SUMMARY OF INVENTION

### Technical Problem

Since a disparity remapping technique based on the viewpoint requires measuring the viewpoint position of a 3D observer, the number of 3D observers is limited to one. For a 2D observer, the image quality of the image further deteriorates because the blurring and double images of the image change every time the 3D observer moves his/her viewpoint. For this reason, when applying a disparity remapping technique based on the viewpoint to a 3D TV, there is a problem in that the number of observers is reduced to one, and the advantage over goggle-type displays, which allows multiple people to enjoy the display in the same place, is completely lost. Furthermore, in Hidden Stereo, there is a limit to the amount of disparity that can be provided, which is about 6 to 8 minutes in viewing angle. Since the amount of disparity included in a normal stereo image is about 1 to 2 degrees (1 degree=60 minutes), it is necessary to compress the disparity in order to reproduce all of this disparity with Hidden Stereo. However, if disparity is simply compressed, fine differences in depth cannot be expressed, resulting in a flat image.

### Solution to Problem

In order to solve the above problems, a stereo image generation device according to the disclosed technology is a device that generates a stereo image from image information, a disparity map of an image, and viewpoint information of an observer, the stereo image generation device including a disparity remapping function generation unit, a multi-band disparity map generation unit, a disparity guidance pattern generation unit, and an image pair generation unit.

The disparity remapping function generation unit generates a remapping function for converting an amount of disparity of pixels belonging to a certain range from a viewpoint into an amount of disparity within a predetermined range. The multi-band disparity map generation unit generates a first multi-band disparity map by low-pass filtering a disparity map, and generates a second multi-band disparity map by correcting the first multi-band disparity map with the disparity remapping function.

The disparity guidance pattern generation unit generates a first band-pass image by band-pass decomposing image information, generates a second band-pass image by shifting the first band-pass image by π/2 in a spatial phase, and generates a disparity guidance pattern by weighting the second band-pass image by adding a value of the second multi-band disparity map.

The image pair generation unit generates a stereo image pair by adding and subtracting the image information and the disparity guidance pattern.

### Advantageous Effects of Invention

The disclosed technology combines disparity remapping based on viewpoint position and Hidden Stereo to create a system in which these technologies compensate for each other's weaknesses. Specifically, Hidden Stereo allows 2D observers to enjoy images at the same time, thereby compensating for the weakness of a “disparity remapping technique based on the viewpoint position,” which is limited to only one observer. On the other hand, the “disparity remapping technique based on the viewpoint position” improves the sense of depth provided by Hidden Stereo by performing remapping so that the amount of disparity near the viewpoint position is 8 minutes or less, which is the constraint range of Hidden Stereo. Fusion is the process by which humans fuse retinal images between both eyes in the brain without blurring them. It is known that the maximum amount of disparity that can be fused is about 10 minutes (Panum's fusion area). Under natural observation conditions, the amount of disparity near the gaze point is concentrated around 0 due to convergence eye movement, and therefore such a fusion limit is not a problem in many cases. Since the disparity remapping results provided by the present invention do not deviate much from the disparity conditions close to those in the natural environment, a relatively natural observing experience can be provided.

### BRIEF DESCRIPTION OF DRAWINGS

FIG. 1 is a diagram illustrating a focal length and a convergence distance.

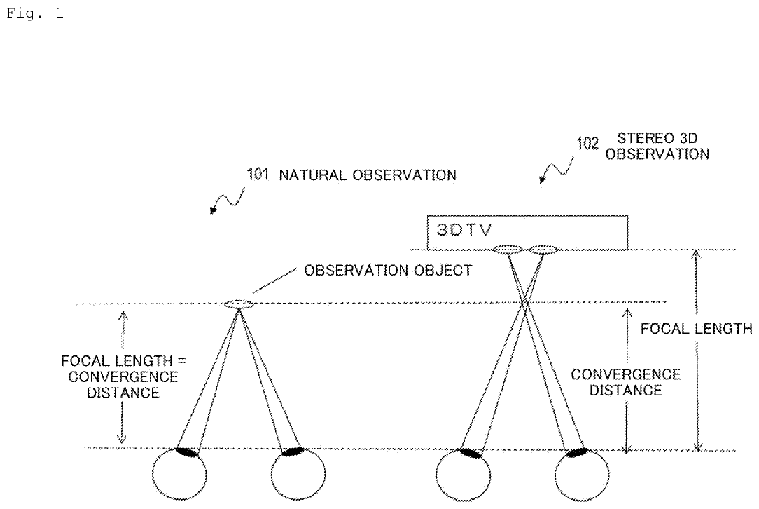

FIG. 2 is a diagram illustrating “remapping” in the related art.

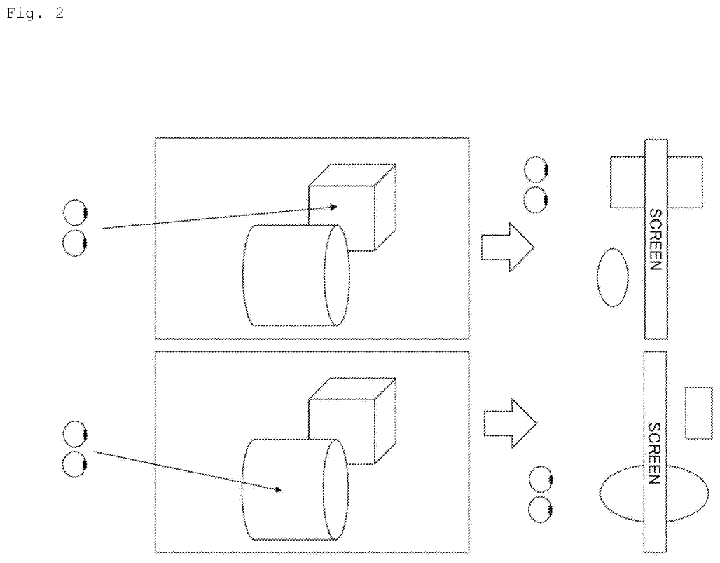

FIG. 3 is a diagram illustrating “Hidden Stereo” in the related art.

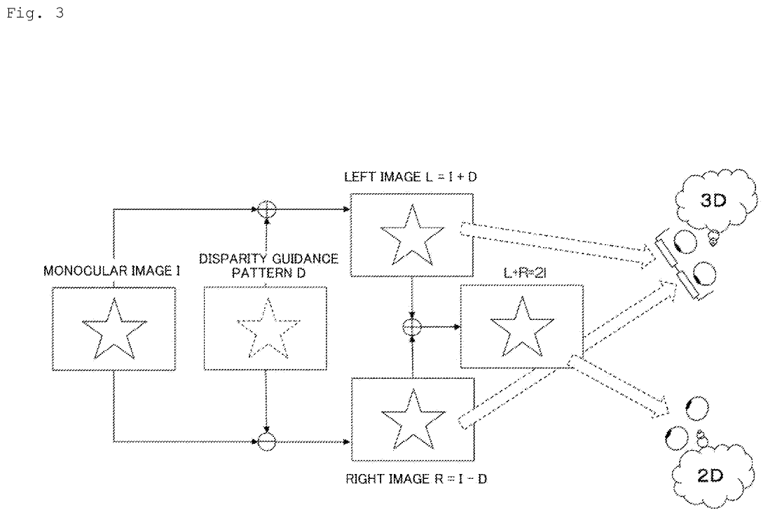

FIG. 4 is a diagram illustrating Equation 1.

FIG. 5 is a diagram illustrating the amount of positive disparity and the amount of negative disparity.

FIG. 6 is a functional block diagram of a stereo image generation device according to a first embodiment.

FIG. 7 is a flowchart showing an operation of a disparity remapping function generation unit.

FIG. 8 is a diagram illustrating a disparity remapping function.

FIG. 9 is a flowchart showing an operation of a multi-band disparity map generation unit.

FIG. 10 is a flowchart showing an operation of a disparity guidance pattern generation unit.

FIG. 11 is a flowchart showing an operation of an image pair generation unit.

FIG. 12 is a functional block diagram of a stereo image generation device according to second and third embodiments.

FIG. 13 is a flowchart showing an operation of a disparity map generation unit.

FIG. 14 is a flowchart showing an operation of a multi-band disparity map generation unit according to the third embodiment.

FIG. 15 is a diagram illustrating an example of a functional configuration of a computer.

### DESCRIPTION OF EMBODIMENTS

Hereinafter, embodiments of the disclosed technology will be described in detail. Note that components having the same function are denoted by the same number, and redundant description will be omitted.

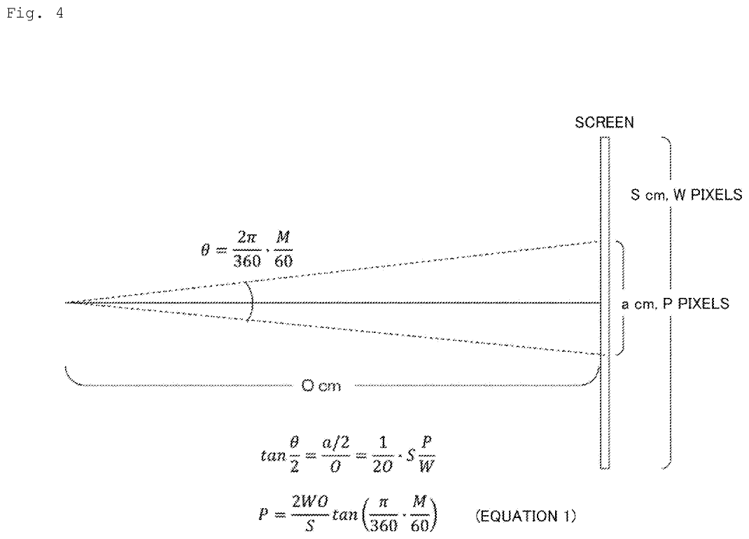

In the following, viewing angle (minutes) is used as a quantitative unit to designate disparity and range in an image, but this can be converted into pixel units using an observation distance O (cm), a screen size S (cm), and the number W of pixels occupying the screen. For example, when a viewing angle M (minutes) is converted to a value P in pixel units, it is as shown in Equation 1 in FIG. 4.

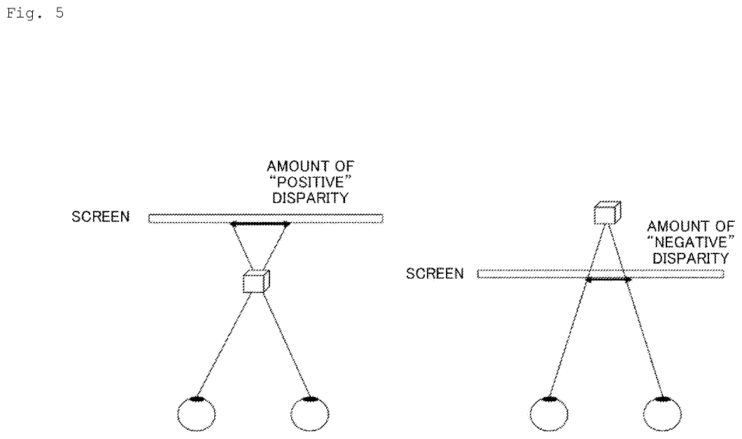

Furthermore, “disparity” is given by the distance between the intersection of the left eye's line of sight and the screen and the intersection of the right eye's line of sight and the screen in a case where the object displayed on the screen is captured at the center of both eyes. FIG. 5 illustrates this situation. It is assumed that disparity can take positive and negative values. Disparity with a positive value represents the depth in front of the screen surface, and disparity with a negative value represents the depth behind the screen surface. Furthermore, it is assumed that disparity 0 represents a depth equal to the screen surface. A disparity map is an array of disparity values for each pixel that matches the image.

Hereinafter, a case in which one 2D image and a corresponding disparity map are input will be described in a first embodiment, and a case in which one stereo image pair is input will be described in a second embodiment and a third embodiment.

### First Embodiment

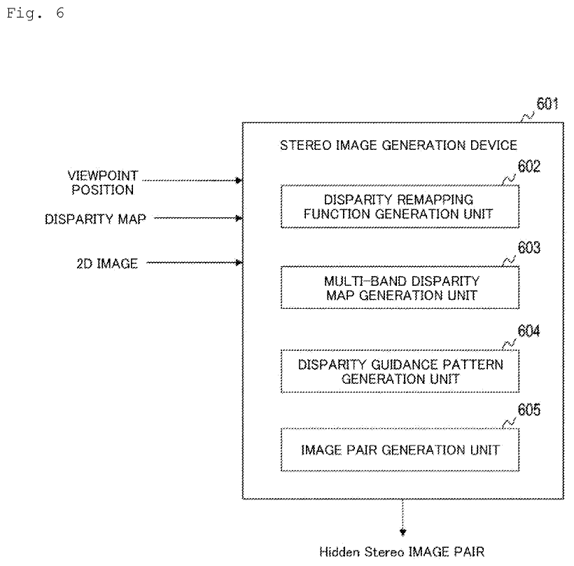

FIG. 6 is a functional block diagram of a stereo image generation device 601 according to a first embodiment.

A disparity remapping function generation unit 602 generates a disparity remapping function g from a disparity map D(x, y) and a viewpoint position (x, y).

A multi-band disparity map generation unit 603 generates a multi-band disparity map G^{D}_{f}(x, y) by remapping the disparity map decomposed into each spatial frequency band using the disparity remapping function g.

A disparity guidance pattern generation unit 604 generates a guidance disparity pattern I_{D}(x, y) from a 2D image I(x, y) and a multi-band disparity map G^{D}_{f}(x, y).

An image pair generation unit 605 generates a Hidden Stereo image pair I_{L}(x, y) and I_{R}(x, y) from the 2D image I(x, y) and the disparity guidance pattern I_{D}(x, y).

### <Generation of Disparity Remapping Function>

A “disparity remapping function” is generated to act on the disparity map to shift the disparity near the viewpoint position to zero and compress the amount of disparity to a range that can be reproduced by Hidden Stereo.

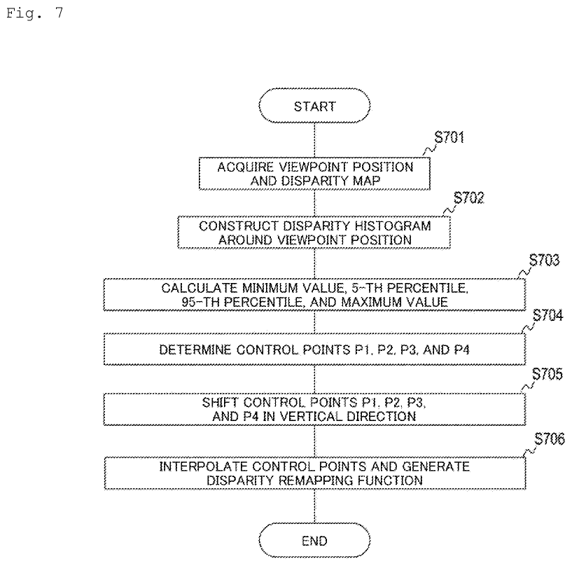

FIG. 7 is a flowchart for describing the operation of the disparity remapping function generation unit.

The disparity remapping function generation unit first acquires a disparity map D(x, y) and a current viewpoint position (x, y) in the image (step S701).

From the disparity map, a histogram is constructed by extracting the amount of disparity of pixels within a visual range of 2.5 degrees centered on the viewpoint position (step S702), and its minimum value min (D), 5-th percentile p₀₅, 95-th percentile p₉₅, and maximum value max (D) are obtained (step S703).

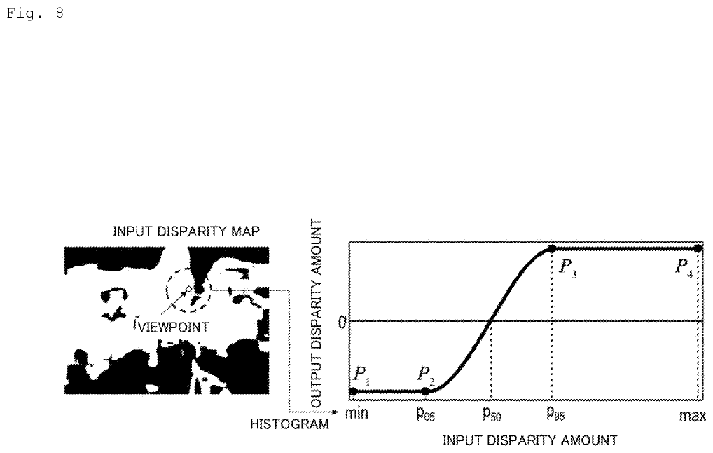

Using an output minimum value dₘᵢₙ and an output maximum value dₘₐₓ of the disparity remapping function, control points P₁, P₂, P₃, and P₄ are determined as follows (step S704 and FIG. 8).

$${P}_{1} = ( min ( D ) , dmin )$$

$${P}_{2} = ( p 05 , dmin )$$

$${P}_{3} = ( p 95 , dmax )$$

$${P}_{4} = ( max ( D ) , dmax )$$

Here, dₘᵢₙ and dₘₐₓ are given as constants as the disparity range that can be reproduced by Hidden Stereo, for example,

$${d}_{min} = - 8 minutes and {d}_{max} = + 8 minutes .$$

In order to make the output disparity 0 at mode value p₅₀ (50-th percentile) of the extracted amount of disparity, the control points P₁ to P₄ are all shifted in the vertical direction so that the straight line connecting P₂ and P₃ passes through the point (p₅₀, 0) (step S705). At this time, the portion where the output value of the control point exceeds the range of dₘᵢₙ and dₘₐₓ may be clipped so that it does not exceed dₘᵢₙ and dₘₐₓ.

The disparity remapping function g is obtained by smoothly interpolating the control points using the Piecewise Cubic Hermite Interpolating Polynomial (PCHIP) method (step S706). FIG. 8 illustrates the disparity remapping function generated by the above procedure.

### <Generation of Multi-Band Disparity Map>

In order to generate Hidden Stereo images according to the viewpoint position, it is necessary to speed up Hidden Stereo image generation processing. For this reason, in the “multi-band disparity map generation unit” and “disparity guidance pattern generation unit” of the disclosed technology, instead of the conversion based on two-dimensional image processing that takes into account spatial frequency and orientation, which was proposed in References 1 and 2 below, conversion is performed based on one-dimensional image processing that takes into account only spatial frequency information in the horizontal direction.

[Reference 1] T. Fukiage et al., “Hiding of phase-based stereo disparity for ghost-free viewing without glasses,” ACM Trans. Graph., vol. 36, No. 4, Article 147, pp. 1-17, July 2017.

[Reference 2] Japanese Patent Application Publication No. 2018-56983

A multi-band disparity map to be used later in the disparity guidance pattern generation unit is generated. The multi-band disparity map is composed of a disparity map G^{D}_{f}(x, y) with a roughness equal to or less than a peak spatial frequency ω_{f} of the spatial frequency band for each of N_{f} spatial frequency bands. Here, f represents the index of each spatial frequency band. Note that N_{f} only needs to be determined according to the number W of pixels in the horizontal direction of the input image, for example, N_{f}=ceiling(log₂W−3). ceiling(x) is a ceiling function that gives the smallest integer equal to or greater than variable x.

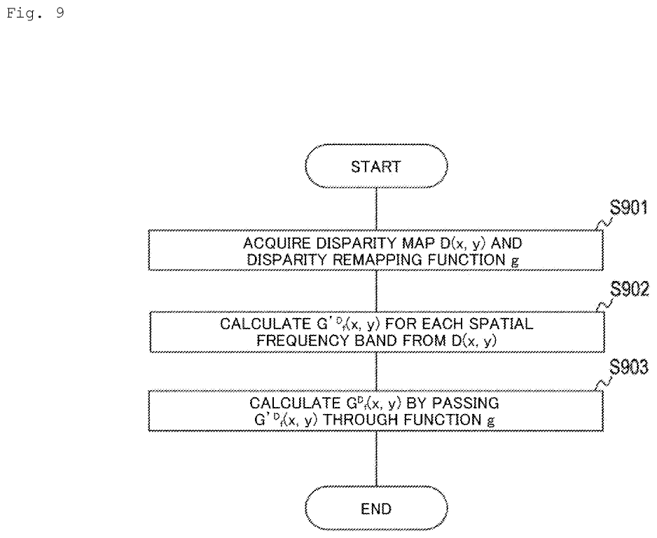

FIG. 9 is a flowchart showing the operation of the multi-band disparity map generation unit.

First, a disparity map D(x, y) and a disparity remapping function g are acquired (step S901).

Next, for the disparity map D(x, y), a moving average in the horizontal direction is calculated for each spatial frequency band f in a neighboring window range of the number of pixels corresponding to the wavelength (low-pass filtering for each band). In order to reduce the amount of calculation, moving average processing is performed independently for each horizontal scanning line, and the results are combined to obtain G′^{D}_{f}(x, y) (step S902).

Thereafter, the disparity of each pixel of G′^{D}_{f}(x, y) is converted through the disparity remapping function g to obtain G^{D}_{f}(x, y) (step S903).

### <Generation of Disparity Guidance Pattern>

The response of a 3D TV is usually not linear, and in order to offset this, the input image is often encoded in a format such as sRGB. At this time, sRGB is converted into a linear RGB space as preprocessing. In the following processing, it is assumed that the same processing is performed independently for each RGB channel. However, in order to reduce the amount of calculation, the disparity guidance pattern may be generated based only on the luminance (Y) channel after converting from RGB to a color space such as YUV.

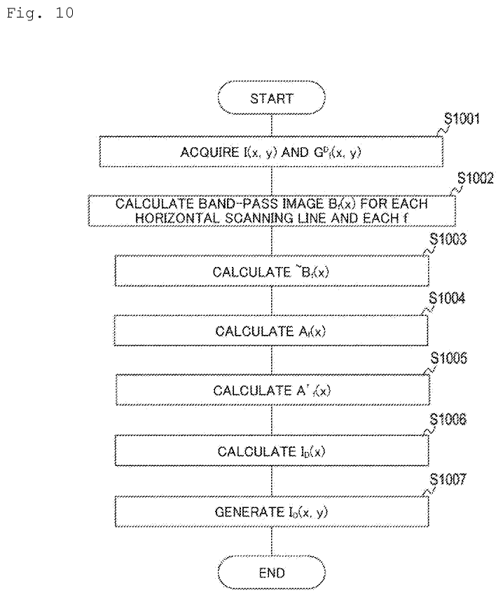

FIG. 10 is a flowchart showing the operation of the disparity guidance pattern generation unit.

First, a 2D image I(x, y) and a multi-band disparity map G^{D}_{f}(x, y) are acquired (step S1001). Since the subsequent processing is performed independently for each horizontal scanning line of row y in the image, I, G^{D}_{f}, and A_{f} will be described without the coordinate y.

A one-dimensional discrete Fourier transform is applied to I(x), and a band-pass filter Ψ_{f} corresponding to each spatial frequency band f is applied. A one-dimensional version of the Complex Steerable Pyramid filter is used as this band-pass filter. However, since spatial frequency bands corresponding to high-pass residual components and low-pass residual components are not used, filters corresponding to these are not used. Thereafter, a discrete inverse Fourier transform is performed to obtain a one-dimensional band-pass image B_{f}(x) for each spatial frequency band f (step S1002, band-pass decomposition).

By extracting the imaginary component of B_{f}(x), a component ˜B_{f}(x) whose spatial phase is shifted by 90 degrees (λ/2) is obtained (step S1003).

A weight A_{f}(x) to be applied to ˜B_{f}(x) is obtained using the following Equation 2 (step S1004).

$${A}_{f} ( x ) = tan ( {ω}_{f} {G}_{f}^{D} ( x ) / 2 ) \qquad ( Equation 2 )$$

In order to prevent the weight from becoming too large in a case where the disparity is large, A_{f}(x) is clipped using Equation 3 below to obtain A′_{f}(x) (step S1005).

$${A}_{f}^{′} ( x ) = min ( max ( {A}_{f} , - 1 ) , 1 ) \qquad ( Equation 3 )$$

Note that max (a, b) is a function that returns the larger value of a and b, and min(a, b) is a function that returns the smaller value of a and b.

Finally, a 90 degree (π/2) phase shift component (A′_{f}(x)˜B_{f}(x)) weighted by A′_{f}(x) is subjected to a discrete Fourier transform, a band-pass filter Wf is applied, and a discrete inverse Fourier transform is performed to obtain a disparity guidance pattern ID (x) for each scanning line (step S1006). A disparity guidance pattern I_{D}(x, y) is obtained by connecting ID(x) in the y direction (step S1007).

### <Generation of Hidden Stereo Image Pair>

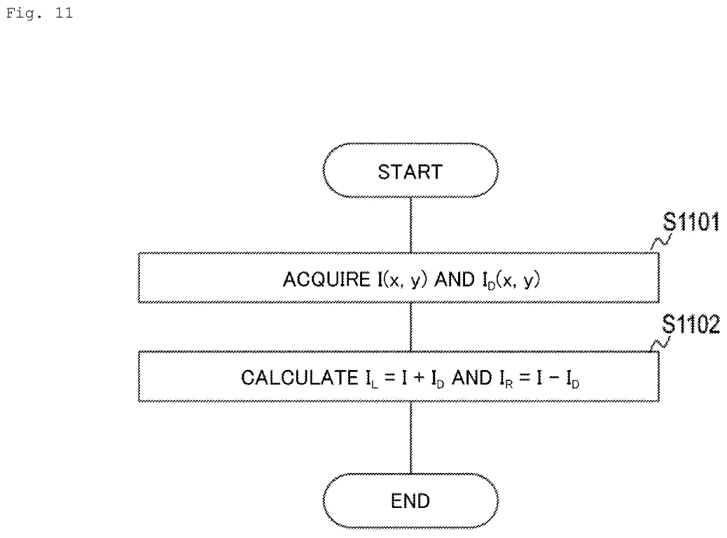

FIG. 11 is a flowchart showing the operation of the Hidden Stereo image pair generation unit.

First, a 2D image I(x, y) and a disparity guidance pattern I_{D}(x, y) are acquired (step S1101). Next, a Hidden Stereo image pair is generated by addition/subtraction processing for each pixel, such as the left image I_{L}(x, y)=I(x, y)+I_{D}(x, y) and the right image I_{R}(x, y)=I(x, y)−I_{D}(x, y) (step S1102).

In a case where a disparity guidance pattern is generated only for the luminance channel, the above processing is performed on the Y channel and then converted to the RGB color space. Then, if necessary, the image is converted from the linear RGB space to the sRGB space and then output to the 3D TV. In a case where the range of displayable pixel values is exceeded by the addition/subtraction processing, components exceeding this range may be calculated and removed from I_{D}(x, y) in advance by clipping processing.

### Second Embodiment

A case will be described in which a stereo image pair is given as an input image.

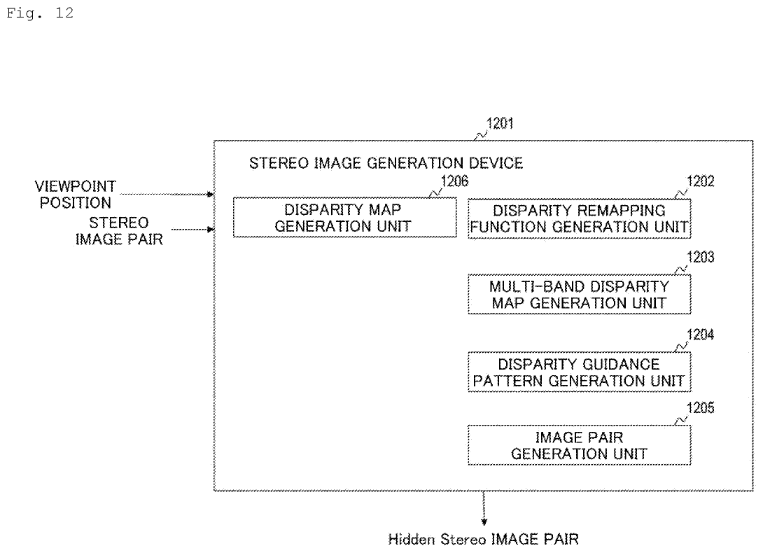

FIG. 12 is a functional block diagram of a stereo image generation device 1201 according to a second embodiment. This embodiment differs from the first embodiment in that the input is a stereo image pair and that a disparity map generation unit 1206 that generates a disparity map from the stereo image pair is provided.

### <Generation of Disparity Map>

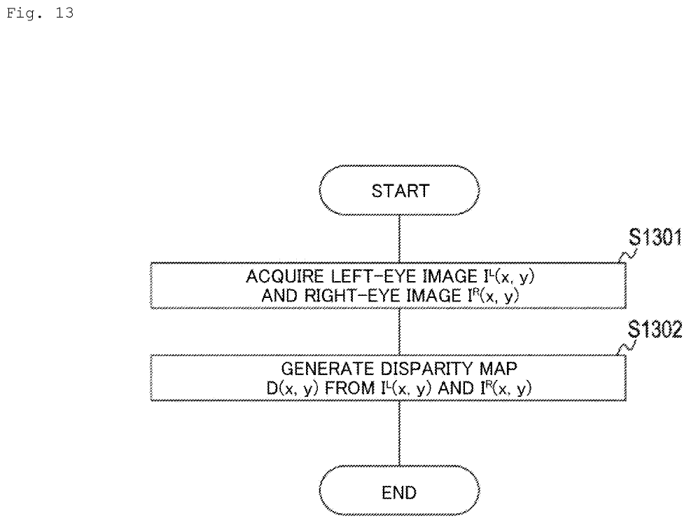

FIG. 13 is a flowchart for describing an operation of a disparity map generation unit.

The disparity map generation unit first acquires a left-eye image I^{L}(x, y) and a right-eye image I^{R}(x, y) (step S1301). Next, a disparity map D(x, y) is generated from I^{L}(x, y) and I^{R}(x, y) (step S1302). To generate D(x, y), for example, the existing technique described in Reference 3 below may be used.

[Reference 3] A. Hosni et al., “Fast cost-volume filtering for visual correspondence and beyond,” IEEE Transactions on Pattern Analysis and Machine Intelligence, vol. 35, No. 2, pp. 504-511, February 2013.

### <Generation of Disparity Remapping Function>

The procedure for generating a disparity remapping function according to the second embodiment is the same as that in the first embodiment.

### <Generation of Multi-Band Disparity Map>

The procedure for generating a multi-band disparity map according to the second embodiment is the same as that of the first embodiment.

### <Generation of Disparity Guidance Pattern>

To generate the disparity guidance pattern according to the second embodiment, a left-eye image I^{L}(x, y) is used instead of the 2D image I(x, y) of the first embodiment. Other procedures are the same as those of the first embodiment.

### <Generation of Hidden Stereo Image Pair>

The procedure for generating a Hidden Stereo image pair according to the second embodiment is the same as that of the first embodiment.

### Third Embodiment

In the second embodiment, a disparity map is generated from a stereo image pair using an existing technique, but in order to obtain a disparity map with higher accuracy, a disparity correction process based on the phase described in Reference 4 below may be performed. In addition to obtaining sub-pixel-accurate disparity, the correction process may also provide more robust results in situations where a plurality of disparities may exist in the same pixel, such as with glossy or translucent objects.

[Reference 4] P. Kellnhofer et al., “3DTV at home: eulerian-lagrangian stereo-to-multiview conversion,” ACM Transaction on Graphics, vol. 36, No. 4, Article 146, pp. 1-13, July 2017.

The functional block diagram of the stereo image generation device according to the third embodiment is the same as the functional block diagram (FIG. 12) of the second embodiment. <Generation of Disparity Map>

The procedure for generating a disparity map according to the third embodiment is the same as that of the second embodiment. <Generation of Disparity Remapping Function>

The procedure for generating a disparity remapping function according to the third embodiment is the same as that in the first embodiment.

### <Generation of Multi-Band Disparity Map>

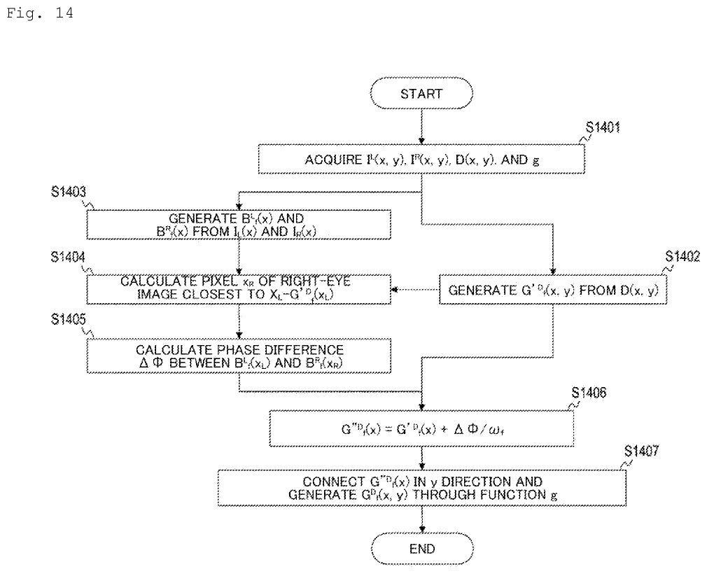

FIG. 14 is a flowchart for describing an operation of a multi-band disparity map generation unit according to the third embodiment.

The multi-band disparity map generation unit first acquires a stereo image pair I^{L}(x, y) and I^{R}(x, y), a disparity map D(x, y), and a disparity remapping function g (step S1401). Next, for the disparity map D(x, y), a moving average in the horizontal direction is calculated for each spatial frequency band f in a neighboring window range of the number of pixels corresponding to the wavelength. In order to reduce the amount of calculation, moving average processing is performed independently for each horizontal scanning line, and the results are combined to obtain G′^{D}_{f}(x, y) (step S1402).

I^{L}(x) and I^{R}(x) obtained by dividing I^{L} and I^{R} into scanning line units are subjected to the same processing as in step S1002 of the first embodiment, and one-dimensional band-pass images B^{L}_{f}(x) and B^{R}_{f}(x) for each spatial frequency band f are obtained (step S1403). B^{L}_{f}(x) obtained here may be directly used as B_{f}(x) in the disparity guidance pattern generation unit.

On the basis of the multi-band disparity map G′^{D}_{f}(x), corresponding points between B^{L}_{f}(x) and B^{R}_{f}(x) are found for each spatial frequency band f. As the pixel x_{R} of B^{R}_{f}(x) corresponding to the x_{L}-th pixel of B^{L}_{f}(x), the pixel closest to x_{L}-G′^{D}_{f}(x_{L}) is calculated (step S1404).

Next, a phase difference Δσ between B^{L}_{f}(x_{L}) and B^{R}_{f}(x_{R}) is calculated (step S1405).

Next, G′^{D}_{f}(x) is corrected by Δσ using Equation 4 below to obtain G″^{D}_{f}(x) (step S1406).

$${G}_{f}^{″ D} ( x ) = {G}_{f}^{′ D} ( x ) + Δφ / {ω}_{f} \qquad ( Equation 4 )$$

Finally, G″^{D}_{f}(x) is connected in the y direction to generate G″^{D}_{f}(x, y), the disparity of each pixel is converted through the disparity remapping function g, and G^{D}_{f}(x, y) is obtained (step S1407).

### <Generation of Disparity Guidance Pattern>

To generate the disparity guidance pattern according to the third embodiment, a left-eye image I^{L}(x, y) is used instead of the 2D image I(x, y) of the first embodiment. Other procedures are the same as those of the first embodiment.

### <Generation of Hidden Stereo Image Pair>

The procedure for generating a Hidden Stereo image pair according to the third embodiment is the same as that of the first embodiment.

### Program, Recording Medium

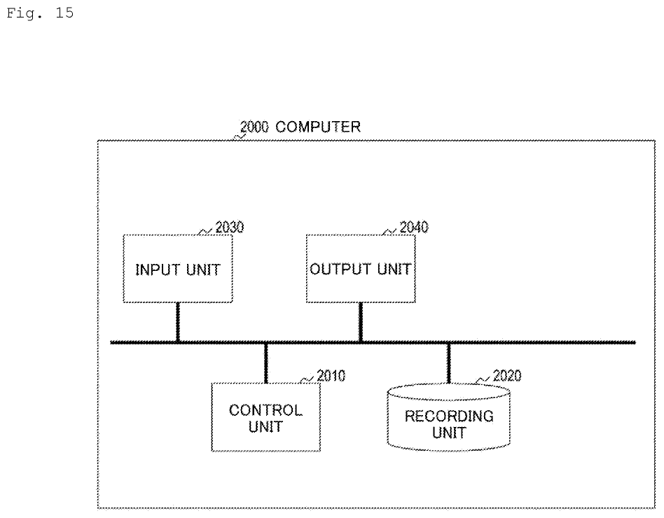

The aforementioned various types of processing can be carried out by causing a recording unit 2020 of a computer 2000 illustrated in FIG. 15 to load a program for executing steps of the above method, and causing a control unit 2010, an input unit 2030, an output unit 2040, a display unit 2050, and the like to operate the program.

A program describing the processing content can be recorded on a computer-readable recording medium. As the computer-readable recording medium, for example, any of a magnetic recording device, an optical disc, a magneto-optical recording medium, and a semiconductor memory may be used.

Further, the distribution of this program is carried out by, for example, selling, transferring, or lending a portable recording medium such as a DVD or a CD-ROM on which the program is recorded. Further, the program may be distributed by storing the program in a storage device of a server computer and transferring the program from the server computer to other computers via a network.

The computer executing such a program first stores a program recorded in a portable recording medium or a program transferred from the server computer temporarily into a storage device of the computer, for example. At the time of execution of a process, the computer reads the program stored in the recording medium of the computer, and executes processing in accordance with the read program. As another execution form of the program, a computer may directly read the program from a portable recording medium and execute processing in accordance with the program. Further, whenever the program is transferred from the server computer to the computer, the processing may be executed in order in accordance with the received program. The above-described processing may be executed by a so-called application service provider (ASP) type service that realizes a processing function in accordance with only an execution instruction and result acquisition without transferring the program from the server computer to the computer. Note that the program in the present embodiment includes information that is used for processing by an electronic computer and is equivalent to the program (data or the like that is not a direct command to the computer but has property that defines processing performed by the computer).

Although the device is configured by executing a predetermined program on a computer in the present embodiment, at least a part of these processing contents may be implemented by hardware.

1. A stereo image generation device that generates a stereo image from image information, a disparity map of an image, and viewpoint information of an observer, the stereo image generation device comprising:
a disparity remapping function generation unit that generates a disparity remapping function for converting an amount of disparity of pixels belonging to a certain range from a viewpoint into an amount of disparity within a predetermined range;
a multi-band disparity map generation unit that generates a first multi-band disparity map by low-pass filtering a disparity map, and generates a second multi-band disparity map by correcting the first multi-band disparity map with the disparity remapping function;
a disparity guidance pattern generation unit that generates a first band-pass image by band-pass decomposing image information, generates a second band-pass image by shifting the first band-pass image by π/2 in a spatial phase, and generates a disparity guidance pattern by weighting the second band-pass image by adding a value of the second multi-band disparity map; and
an image pair generation unit that generates a stereo image pair by adding and subtracting the image information and the disparity guidance pattern.

2. The stereo image generation device according to claim 1, wherein
the image information is a stereo image pair I_{L} and I_{R}, and
the multi-band disparity map generation unit performs band-pass decomposition of I_{L} and I_{R} to generate band-pass images B^{L}_{f} and B^{R}_{f}, corrects the first multi-band disparity map on the basis of B^{L}_{f} and BRf, and corrects the corrected first multi-band disparity map using the disparity remapping function to generate the second multi-band disparity map.

3. The stereo image generation device according to claim 1, wherein
the multi-band disparity map generation unit processes the disparity map for each horizontal scanning line, and
the disparity guidance pattern generation unit processes the image for each horizontal scanning line.

4. A method of generating a stereo image from image information, a disparity map of an image, and viewpoint information of an observer, the method comprising:
generating a remapping function for converting an amount of disparity of pixels belonging to a certain range from a viewpoint into an amount of disparity within a predetermined range;
generating a first multi-band disparity map by low-pass filtering a disparity map, and generates a second multi-band disparity map by correcting the first multi-band disparity map with the disparity remapping function;
generating a first band-pass image by band-pass decomposing image information, generates a second band-pass image by shifting the first band-pass image by π/2 in a spatial phase, and generates a disparity guidance pattern by weighting the second band-pass image by adding a value of the second multi-band disparity map; and
generating a stereo image pair by adding and subtracting the image information and the disparity guidance pattern.

5. (canceled)

6. A computer-readable non-transitory recording medium storing computer-executable program instructions that when executed by a processor cause a computer to execute a stereo image generation method comprising:
generating a remapping function for converting an amount of disparity of pixels belonging to a certain range from a viewpoint into an amount of disparity within a predetermined range;
generating a first multi-band disparity map by low-pass filtering a disparity map, and generates a second multi-band disparity map by correcting the first multi-band disparity map with the disparity remapping function;
generating a first band-pass image by band-pass decomposing image information, generates a second band-pass image by shifting the first band-pass image by π/2 in a spatial phase, and generates a disparity guidance pattern by weighting the second band-pass image by adding a value of the second multi-band disparity map; and
generating a stereo image pair by adding and subtracting the image information and the disparity guidance pattern.

7. The stereo image generation device according to claim 2, wherein a guidance parallax pattern is generated by using a pair of I_{L} and a multiband parallax map G^{D}_{F}(x,y).
